(19) United States
(12) Patent Application Publication
(10) Pub. No.: US 2026/0037407 A1
(43) Pub. Date: Feb. 5, 2026

(54) PARALLEL CODE FRAGMENTS WITH FOREIGN CODE

(71) Applicant: Unisys Corporation, Blue Bell, PA (US)

(72) Inventors: David STRONG, Irvine, CA (US); Matthew MILLER, Atlanta, GA (US); Anthony MATYOK, West Chester, PA (US); Andrew Ward BEALE, Carolina Shores, NC (US)

(21) Appl. No.: 18/791,669

(22) Filed: Aug. 1, 2024

(51) Int. Cl. G06F 11/36

(52) U.S. Cl. CPC G06F 11/3604

(57) ABSTRACT

In various examples, an executable object including parallel code fragments with foreign code is executed by one or more processors. For example, when a selection mask is enabled, instructions encoded in the executable object are translated for execution by the one or more processors. Continuing this example, the executable object includes the parallel code fragment with the foreign code, once enabled and translated, the foreign code is provided to the target processor for execution.

### BACKGROUND

Computing environments include specific processors and other computing hardware that require specific instruction architecture. In addition, these computing environments can include multiple types of processors or other computing hardware that supports different instruction architectures. For example, a server computer system can be upgraded and/or modified to include a graphics processing unit (GPU). In addition, for certain applications, different computing environments with different architectures (e.g., different combinations of processors and/or computing hardware) are more efficient, faster, less expensive, or otherwise provide a benefit to users. In some instances, new computing hardware is developed and can be added to existing computing environments.

Furthermore, software packages provide expanded feature sets, improved performance, or other advantages based on the underlying processors or computing hardware executing the software packages. However, as an example, the different instruction architectures require users of these computing environments to translate, recompile, obtain new software packages, or otherwise take additional steps to utilize different processors and/or computing hardware within a computing environment. Accordingly, it can be difficult for users to take advantage of additional processors or computing hardware in computing environments.

### SUMMARY

Embodiments described herein include methods and systems for providing foreign code (e.g., executable code in a different instruction architecture) within parallel code fragments in executable code. In one example, the foreign code includes executable instructions that are executable by a different processor than the processors executing the executable code including the parallel code fragment. In an embodiment, the parallel code fragments including foreign code are selected during code translation in a computing environment and provided to the corresponding processor (e.g., the computing hardware that can execute the instructions encoded in the different instruction architecture of the foreign code), thereby causing the corresponding processor to execute the foreign code.

Advantageously, in various embodiments, the systems and methods described allow or otherwise enable users to utilize processors or computing hardware within a computing environment. In particular, the parallel code fragments including foreign code can be enabled dynamically without the need to recompile or otherwise cause any down time for the computing environment or component thereof. For example, a user can enable parallel code fragments for a different processor type within a computing environment through a user interface without the need to recompile the executable code currently being executed by processors of the computing environment.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which an executable object including parallel code fragments with foreign code is executed, in accordance with at least one embodiment.

FIG. 3 depicts an environment in which an executable object including parallel code fragments with foreign code is executed by a set of processors, in accordance with at least one embodiment.

FIG. 4 depicts an environment in which a hosted environment executes an application using a set of processors, in accordance with at least one embodiment.

FIG. 5 depicts an environment in which an executable object including parallel code fragments with foreign code is executed, in accordance with at least one embodiment.

FIG. 6 depicts an example process flow for enabling execution of parallel code fragments with foreign code, in accordance with at least one embodiment.

FIG. 7 depicts an example process flow for generating an executable object including parallel code fragments with foreign code, in accordance with at least one embodiment.

FIG. 8 depicts an example process flow for executing an executable object including parallel code fragments with foreign code using a set of processors, in accordance with at least one embodiment.

FIG. 9 is a block diagram of an exemplary computing environment suitable for use in implementations of the present disclosure.

### DETAILED DESCRIPTION

Embodiments described herein generally relate to enabling the execution of foreign code within parallel code fragments in executable code. In accordance with some aspects, the systems and methods described generate an executable object (e.g., an executable file, processor executable, or other data that can be directly executed by a processor) that includes parallel code fragments with foreign code that can be executed in a particular computing environment. For example, selection of the parallel code fragment causes execution of the foreign code by a processor, in the computing environment, that supports the instruction architecture associated with the foreign code. In various embodiments, the executable object is compiled or otherwise generated in accordance with a first syntax and/or first instruction architecture and includes executable code (e.g., machine code) within a parallel code fragment that is compiled or otherwise generated in accordance with a second syntax and/or second instruction architecture (e.g., foreign relative to the first syntax and/or first instruction architecture).

In one example, a computing environment, such as a server computer system, includes a processor or other computer hardware that, as a result of executing instructions, causes the computing environment to perform operations encoded in the instructions. Continuing this example, the instructions are translated, compiled, or otherwise generated based on a particular instruction architecture (e.g., an instruction set associated with the processor) and included in an executable object that can be stored within the computing environment for execution by the processor or other computer hardware. The executable object, in an embodiment, is generated as a result of a compilation process that translates source code written in a programming language to machine code that is executable directly by the processor or other computer hardware.

Furthermore, in various embodiments, the executable object includes parallel code fragments that include native and non-native instructions (e.g., foreign code relative to the operating system and/or processor). For example, by determining a set of processors or computing hardware available to a computing environment, parallel code fragments are translated into instructions corresponding to the instruction architecture of a corresponding processor or computing hardware. Continuing this example, different computing environments can translate the executable code using different selections from among the parallel code fragments based on the capabilities of the particular computing environment.

In various embodiments, different computing environments enable different parallel code fragments based on the processors or computing hardware available to the computing environments to execute the foreign code within the parallel code fragments. Such differences in computing environments, for example, results in differences in performance (e.g., by providing access to different instructions, different instruction architecture extensions, different algorithms for executing the same instructions, faster computing hardware, more efficient computing hardware, increased parallelism, etc.), or differences in operation (e.g., by adding or removing features based on the capabilities of processors or computing hardware available to the computing environment).

Furthermore, in some embodiments, a compiler identifies specific processes that are translatable into a plurality of different executable code fragments. For example, the compiler automatically includes parallel code fragments including foreign code based on a configuration of the compiler (e.g., based on an instruction to the compiler as to the types of processors or computing hardware available to the computing environment and a list of code segments that result in compilation into parallel code fragments). In various embodiments, the parallel code fragments are used to include operations (e.g., instructions) to be executed by separate computing hardware (e.g., by a different processor than the processor executing the executable object including the parallel code fragments) by allowing selection of a particular fragment to be executed by the separate computing hardware based on a handshaking operation between a executable object and an operating system to determine the computing hardware available to execute the foreign code. In one example, a user is able to selectively activate or deactivate the parallel code fragments with the executable object (e.g., through a command to the operating system associated with the computing environment).

Other solutions do not allow the inclusion of foreign code, or if such code is included in executables, the code causes an error in the process and/or processors. In one example, foreign code included in an executable and the corresponding operations encoded within that foreign code are ignored by the processor. Furthermore, other systems do not allow for the selective activation of parallel code fragments. For example, these systems require the computing environment to recompile the source code or otherwise retranslate the executable object including the parallel code fragments in order to enable execution. As described above, in such examples, this causes downtime and may be undesirable in certain situations.

Aspects of the technology described herein provide a number of improvements over existing technologies. For instance, significant flexibility is provided to the software developers to deliver a single executable code package to users that can be executed on a plurality of different hardware configurations and computing environments. In one example, a plurality of different foreign codes can be included in a single executable object without the need for the developer to generate different versions of executable and/or libraries for execution by different computing environments. In addition, users can take advantage of new or additional computing hardware available in various computing environments dynamically. For example, this is particularly advantageous in circumstances where overhead associated with various operations (e.g., logging and/or debugging) is not always required, but may be advisable to be included for at least some limited time during execution. Furthermore, in various embodiments, the inclusion of foreign code in parallel code fragments avoids both performance penalties caused by runtime checks and indirect invocations.

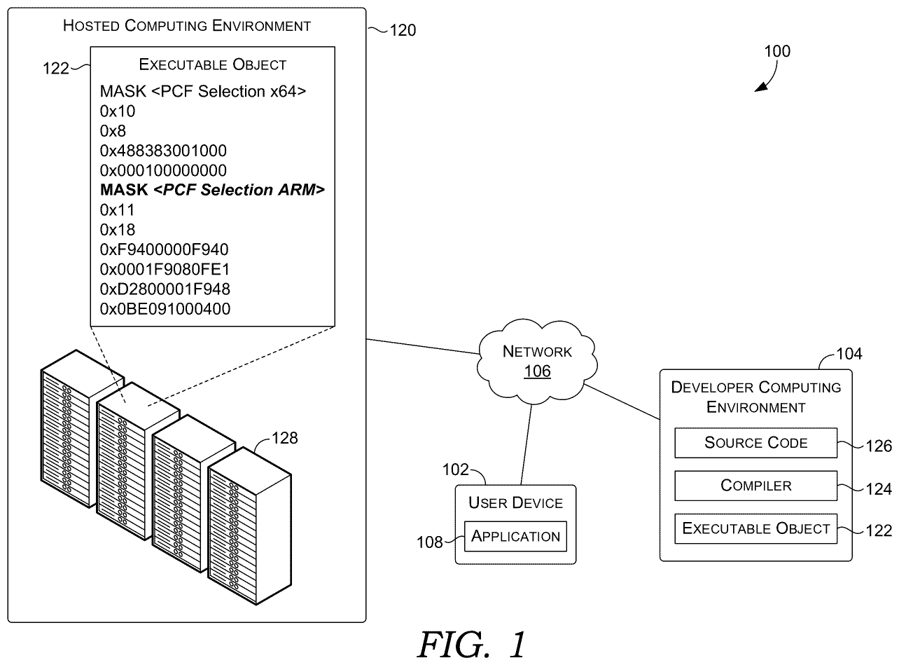

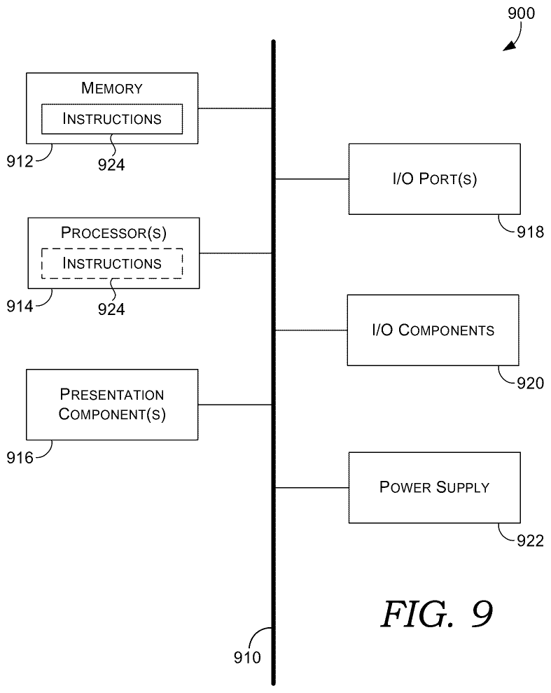

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, developer computing environment 104, a hosted computing environment 120, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the developer computing environment 104 and the hosted computing environment 120 includes multiple server computer systems 128 cooperating in a distributed environment to perform the operations described in the present disclosure.

User device 102 can be any type of computing device capable of being operated by an entity (e.g., individual or organization) and obtains data from developer computing environment 104 and/or a data store which can be facilitated by the hosted computing environment 120 (e.g., a server operating as a frontend for a server computer system 128). The user device 102, in various embodiments, has access to or otherwise obtains an executable object 122 from the developer computing environment. For example, the application 108 includes the executable object 122, that is compiled, using the compiler 124 based on the source code 126. Continuing this example, the application 108 is executed by a set of processors included (e.g., the server computer systems 128) included in the hosted computing environment 120.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the hosted computing environment 120. For example, the application 108 includes a terminal or other application for communicating with server computer systems 128 within the hosted computing environment 120. In other examples, the application 108 allows the user device 102 to communicate and/or execute the executable object 122 using computing resources of the hosted computing environment 120.

In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the hosted computing environment 120. In some cases, the application 108 is integrated into the operating system (e.g., as a service). It is therefore contemplated herein that “application” be interpreted broadly.

For cloud-based implementations, for example, the application 108 is utilized to interface with the functionality implemented by the hosted computing environment. In some embodiments, the components, or portions thereof, of the developer computing environment 104 are implemented within the hosted computing environment 120 or other systems or devices. For example, the compiler 124 is executed within the hosted computing environment 120. In addition, it should be appreciated that the hosted computing environment 120, the user device 102, and the developer computing environment 104, in some embodiments, are provided via multiple devices arranged in a distributed environment that collectively provide the functionality described herein. Additionally, other components not shown can also be included within the distributed environment.

As illustrated in FIG. 1, computing resources within the hosted computing environment 120, such as server computer systems 128 including processors and memory, are used to execute executable instructions encoded in an executable object 122. In addition, in various embodiments, the executable object 122 includes parallel code fragments that contain foreign code. In one example, a parallel code fragment includes foreign code (e.g., relative to the processor executing the executable object 122), where the foreign code is encoded based on an instruction architecture that is distinct from the instruction architecture of the executable object. In this manner, in an embodiment, the executable object 122 is executed by a first type of processor having a first instruction architecture, and the foreign code encoded in the parallel code fragment is executed by a second type of processor with a second instruction architecture. In one example, the parallel code fragments are embedded within the executable object 122 (e.g., native code) as a series of literal values represented as a contiguous sequence of bytes. In addition, other formats of the executable object 122 and instructions illustrated in FIG. 1 can be used in accordance with various embodiments. In one example, a system represents the foreign code using a sequence of native instructions that accept literal values as a parameter.

Furthermore, in various embodiments, the parallel code fragments are dynamically selected for execution without needing to recompile the source code 126 or other executable instructions encoded in the executable object 122. In one example, the parallel code fragments are enabled via selection through the application 108. In various embodiments, a selection mask associated with the parallel code fragments is provided to firmware, an operating system, or another application managing execution of the executable object 122 within the hosted computing environment 120, which then can enable the parallel code fragments during execution by at least identifying and/or detecting the selection mask within the executable object 122. In one example, this allows for the use of a single version of the source code and/or executable object and reduces packaging overhead of developers by enabling developers to compile a single executable object 122 with a plurality of parallel code fragments that can be dynamically enabled including parallel code fragments with foreign code.

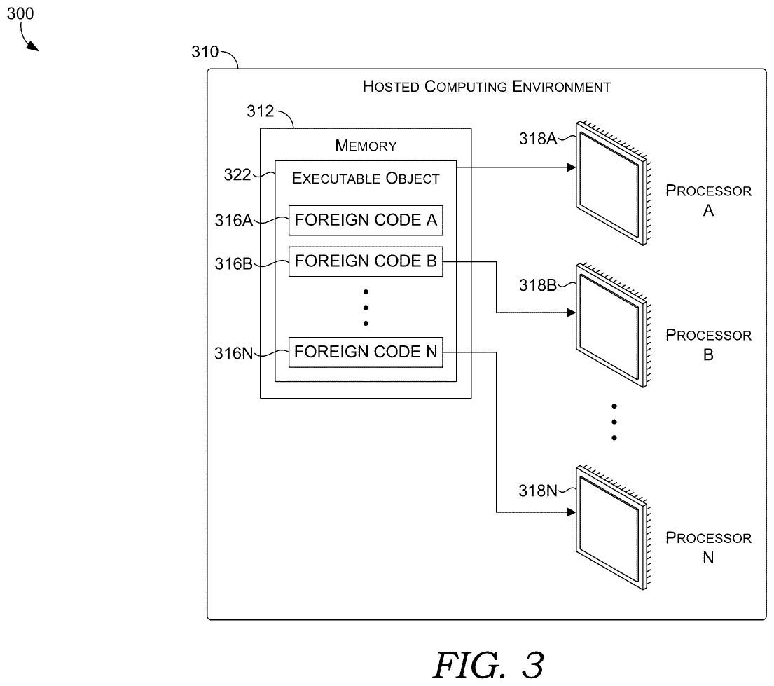

In various embodiments, a developer generates source code 126 that is compiled by a compiler 124 within a developer computing environment 104 to generate the executable object 122. In one example, the developer includes, in the source code 126, instructions to be executed by additional processors as described in detail below in connection with FIG. 3. In various embodiments, the compiler generates the selection mask included in the executable object that, once enabled, allows the hosted computing environment 120 to execute the foreign code within the parallel code fragment. In addition, in one example, the selection mask includes metadata or other information that indicates to the hosted computing environment 120 that foreign code is included in the parallel code fragment and other information to enable execution of the parallel code fragment.

In various embodiments, the hosted computing environment 120 includes an operating system that generates a process to manage or otherwise handle execution of the executable object 122. In such embodiments, the process is identified by a process identification number (e.g., process ID) or other information to enable the selection mask, in response to a user (e.g., through the application 108) enabling parallel code fragments, to be provided to the process executing the executable object 122. In various embodiments, the hosted computing environment 120 obtains the selection mask and determines (e.g., based at least in part on metadata included in the selection mask) if the hosted computing environment 120 includes a processor, including virtual processor, or other computing hardware suitable for executing the foreign code. For example, the hosted computing environment 120 determines if there is computing hardware or virtualized computing hardware that can process the instruction architecture encoded in the foreign code within the executable object 122.

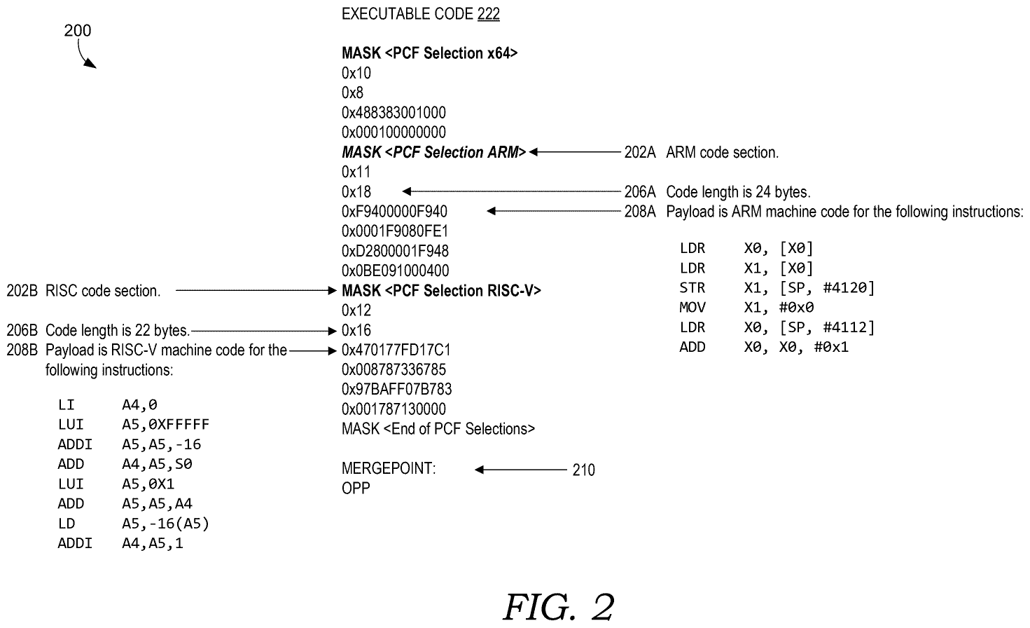

In various embodiments, once the selection mask is obtained the hosted computing environment 120 or component of the hosted computing environment 120 (e.g., firmware, operating system, utility, etc.) retranslates the executable object during execution to activate the parallel code fragments. During execution of the executable object 122 with the selection mask enabled, for example, the hosted computing environment 120 or component of the hosted computing environment 120 processes the machine code in the executable object and provides the foreign code to the corresponding processor for execution and, in some instances, obtains a result from the corresponding processor. Continuing this example, the result is obtained and is synchronized at a merge point within the executable object 122, as described below in connection with FIG. 2.

In various embodiments, the operating system and the firmware of the hosted computing environment 120 negotiate or otherwise determine whether the parallel code fragments within the executable object 122 can be enabled. For example, the firmware indicates to the operating system the instruction architectures that are supported (e.g., x64, Reduced Instruction Set Computer [RISC], Advanced RISC Machines [ARM], etc.) within the hosted computing environment 120, and the operating system can determine instruction architectures included in the foreign code within the parallel code fragments. Continuing this example, information indicating the parallel code fragments (e.g., which include foreign code) are supported by the hosted computing environment 120 is exposed to the user through a user interface of the operating system and/or application 108, to allow the user to make a selection of particular parallel code fragments and/or capabilities of the hosted computing environment 120 to enable. In various embodiments, this information is presented through a user interface. For example, the user interface can include a toggle or other button to allow the user to turn on or off various capabilities (e.g., additional and/or alternative instruction architectures, processors, and/or parallel code fragments). In response to enabling a particular parallel code fragment and/or capability, a handshake operation or other negotiation between the operating system and the firmware is performed to enable the process executing the executable object 122 to enable the particular parallel code fragment and/or capability.

In various embodiments, the operating system includes attributes (e.g., file attributes or other characteristics of a file) that include information corresponding to the parallel code fragments or capabilities supported by the executable object 122 and/or hosted computing environment 120. Returning to the example above, these attributes are queried to determine or otherwise populate the user interface and/or enable the handshake operation between the operating system and the firmware.

In various embodiments, during execution of the executable object 122 the machine code is unpacked and reassembled as a contiguous sequence of bytes then provided or otherwise offloaded to an additional and/or secondary processor. For example, the executable code, machine code, or other executable instructions included in the executable object 122 (e.g., a code stream) includes metadata or other enumeration indicating the type of instruction architecture and or machine code, how large the machine code is (e.g., the number of bytes of the foreign code), and the machine code to be executed by the additional and/or secondary processor.

In various embodiments, Dynamic Binary Translation (DBT) is used to provide the foreign code to a particular target processor (e.g., the additional and/or secondary processor indicated in the selection mask). DBT, in one example, includes binary recompilation where sequences of instructions are translated from a source instruction architecture to the target instruction architecture. In an embodiment, DBT obtains a short sequence of code (e.g., a single basic block of instructions included in the executable object 122) then translates the sequence of code and caches the resulting sequence. Furthermore, in some embodiments, the code is only translated as it is discovered or otherwise executed along an execution path, and branch instructions are made to point to already translated and saved code. In one example, a series of six byte entities of code are translated and cached or otherwise stored in a native buffer for the target processor and an instruction pointer is modified to point to the first byte of the code stored in the native buffer. Continuing this example, the target processor then executes the code and returns a result.

In various embodiments, a Compute Express Link (CXL) is used to provide the foreign code to the target processor included in the hosted computing environment 120. For example, CXL enables cache coherence, memory pooling, and sharing, allowing the sharing of memory between devices. Therefore, in such examples, target processor and the processor executing the executable object 122 can share memory, and instructions can be cached and executed by the corresponding processor during execution.

FIG. 2 illustrates an environment 200 in which an executable object 222 including parallel code fragments with foreign code is encapsulated, informed, and executed by a target processor, and returned with a result in accordance with an embodiment. In one example, the executable object 222 includes source code compiled into an executable object such as the executable object 122 described above in FIG. 1. In various embodiments, if parallel code fragments are not enabled (e.g., the user via the user interface as described above has not selected or otherwise enabled the particular parallel code fragments illustrated in FIG. 2) the selection masks 202A and 202B cause the computer system executing the executable object 222 to ignore the parallel code fragments. In other embodiments, if the parallel code fragments are enabled, the selection masks 202A and 202B cause execution of the foreign code.

In various embodiments, the selection masks 202A and 202B correspond to an instruction architecture associated with foreign code included in the parallel code fragment. For example, as illustrated in FIG. 2, the selection mask 202A corresponds to foreign code associated with the ARM instruction architecture and the selection mask 202B corresponds to foreign code associated with the RISC instruction architecture. As described above, in an embodiment, the selection masks 202A and 202 B include metadata containing information to execute the parallel code fragment such as processor capabilities, streaming instructions, instruction architecture, or other information suitable for executing the parallel code fragment and/or foreign code. In various embodiments, the parallel code fragments include a code length 206A and 206B, and a payload 208A and 208B. In addition, in some embodiments, the parallel code fragments include an enumeration value indicating the type of target processor and/or instruction architecture. For example, an enumeration value is included in the parallel code fragment indicating that the payload (e.g., payload 208A or 208B) is to be executed by a Graphics Processing Unit (GPU).

In various embodiments, the code lengths 206A and 206B include a value indicating a length and/or number of bytes of the payload 208A or 208B. For example, code length 206A indicates that the payload 208A is 24 bytes. Continuing this example, the computer system executing the executable object 222 obtains the next 24 bytes of instructions (e.g., the payload 208A) and provides the instructions to the target processor for execution as described above.

In various embodiments, the payloads 208A and 208B include executable code or other instructions that are executable by the target processor. For example, the payload 208A is generated based on source code that is compiled into ARM machine code and included in the executable object 222. In various embodiments, the payloads 208A and 208B include machine code, as illustrated in FIG. 2, corresponding to the instruction architecture associated with the processor type (e.g., ARM, RISC, GPU, Field-Programmable Gate Array [FPGA] etc.) of the target processor.

In various embodiments, the merge point 210 includes common code for the parallel code fragments. For example, the merge point 210 includes instructions and/or operations to perform based on the result obtained from the target processor. In other example, the merge point 210 indicates a location within the executable object 222 to resume execution. For example, the computing device executing the executable object 222 can process the parallel code fragment, transmit the payload 208A to the target processor and resume execution of the executable object 222 at the merge point while the target processor executes the payload 208A in parallel. In various embodiments, the parallel code fragments are executed asynchronously.

FIG. 3 illustrates an environment 300 in which an executable object 322 is executed within a hosted computing environment 310. In one example, the executable object 322 includes source code compiled into an executable object such as the executable object 122 described above in FIG. 1. In various embodiments, the hosted computing environment 310 includes or otherwise has access to a plurality of processors 318A-318N. For example, the processors 318A-318N can include a central processing unit (CPU), GPU, digital signal processor (DSP), tensor processing unit (TPU), microcontroller, field programmable gate array (FGPA), or any other processor capable of executing instructions encoded in the executable object 322. In addition, in some embodiments, one or more of the processors 318A-318N can include a virtual processor. For example, an x64 processor emulating a foreign architecture such as RISC. In various embodiments, the executable object 322 is stored in memory 312. The memory 312, for example, includes various types of memory described below in connection with FIG. 9. In addition, although just a single memory 312 is illustrated in FIG. 3, the hosted computing environment 320 and/or the processors 318A-318N can include additional memory and/or share the memory 312.

In various embodiments, the executable object 322 includes a plurality of foreign code segments 316A-316N. For example, the foreign code segments 316A-316N can be included in parallel code fragments within the executable object 322. In addition, in an embodiment, a processor A 318A executes the executable object 322. For example, the processor A 318A includes a CPU that executes the machine code encoded in the executable object 322. Continuing this example, the processor A 318A executes native code (e.g., the machine code is encoded using an instruction architecture associated with the processor A 318A), and the foreign code segments 316A-316N are encoded in a non-native instruction architecture relative to the processor A 318A. As described above, the hosted computing environment 310 or component thereof (e.g., operating system, firmware, utility, etc.) determines a target processor (e.g., a processor capable of executing instructions encoded in the non-native instruction architecture) and if the target processor is included within the processors 318A-318N.

In various embodiments, if the foreign code execution is enabled, the hosted computing environment 310 or component thereof, when executing a particular foreign code segment of the set of foreign code segments 316A-316N, determines the target processor from the set of the processors 318A-318N and causes the target processor to execute the particular foreign code segment. For example, the foreign code segment B 316B is executable by processor B 318B, and during execution the foreign code segment B 316B is provided to the processor B 318B by updating a pointer associated with the processor B 318B to point to a memory location containing the foreign code segment B 316B.

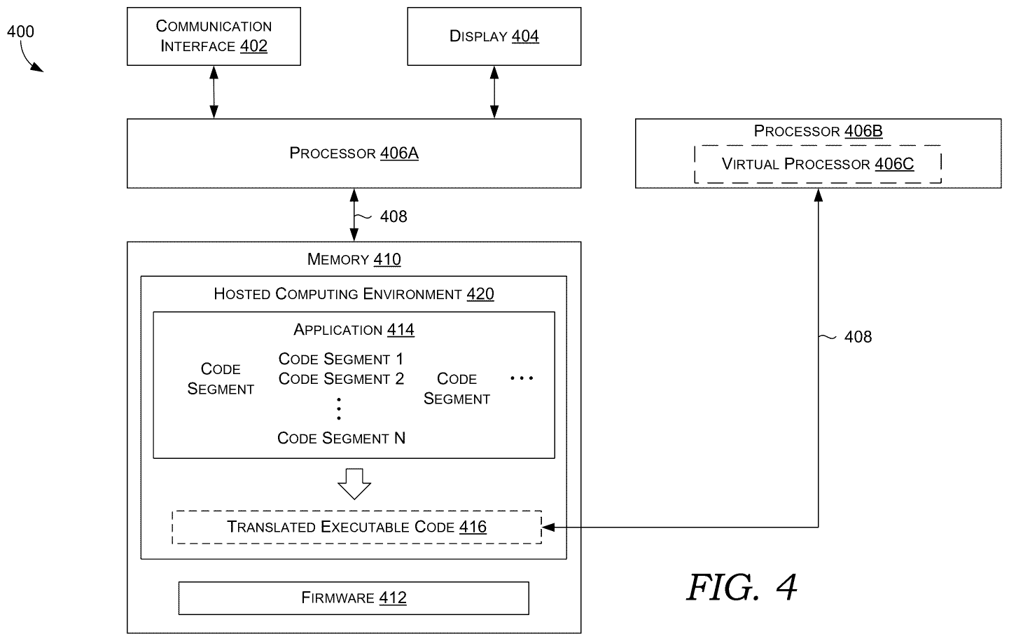

FIG. 4 illustrates an environment 400 in which a hosted computing environment executes a set of parallel code fragments including foreign code in accordance with at least one embodiment. As illustrated in FIG. 4, the environment 400 includes processors 406A and 406B communicatively connected to a memory 410 via a data bus 408. The processors 406A and 406B, for example, include a variety of types of programmable circuits capable of executing computer-readable instructions to perform various tasks, such as mathematical and communication tasks, such as those described below in connection with FIG. 9. Furthermore, the processor 406B includes a virtual processor 406C. For example, the processor 406B emulates a foreign processor. In this manner, in an embodiment, the processors of a computer system are the same (e.g., homogeneous) however the processors available to execute instructions (e.g., parallel code fragments including foreign code) are different (e.g., heterogeneous). In addition, the processors 406A and 406B, in various embodiments, are connected to the memory 410 via the same data bus 408 or separate data buses.

The memory 410 can include any of a variety of memory devices, such as using various types of computer-readable or computer storage media, as also discussed below in connection with FIG. 9. In an embodiment, the memory 410 stores instructions that, as a result of being executed by the processor 406A, provide a hosted computing environment 420, and firmware 412, discussed in further detail below. In various embodiments, the environment 400 includes a communication interface 402 that receives and transmits data. For example, the communication interface 402 provides access to a sharable resource such as a resource hosted by the hosted computing environment 420. Additionally, in various embodiments, a display 404 can be used for viewing a local version of a user interface (e.g., to view executing tasks on the environment 400 and/or within the hosted computing environment 420, to enable parallel code fragments, or to otherwise interact with the environment 400 and/or within the hosted computing environment 420).

In an embodiment, the hosted computing environment 420 is executable from memory 410 by the processor 406A based on execution of firmware 412. In one example, the firmware 412 translates instructions stored in the hosted computing environment 420 for execution from a first instruction architecture of the hosted computing environment 420 to a native instruction architecture of the processor 406A. Continuing this example, the firmware 412 translates instructions from the first instruction architecture to a second instruction architecture for execution by the processor 406A (which in some embodiments is virtualized).

In various embodiments, the hosted computing environment 420 includes or otherwise executes an application 414. For example, the application 414 is written in any programming language, or compiled in an instruction architecture, which is compatible with execution within the hosted computing environment 420. The application 414, in an embodiment, is provided to the environment 400 as executable code including a plurality of parallel code fragments. As discussed below, in some embodiments, the executable code can include a default code set, as well as a set of parallel code fragments useable in place of a portion of that default code set and including foreign code in a non-native instruction architecture (e.g., in an instruction architecture associated with the processor 406B).

In various embodiments, the application 414 (e.g., an executable object that is translated and executed by a processor) includes code segments that are translated into executable code 416, which is performed via cooperation with the hosted computing environment 420 and the firmware 412. For example, the hosted computing environment 420 and firmware 412 translate the application 414 into the executable code 416 using a compilation process or interpretation (e.g., translation and execution concurrently on an instruction-by-instruction basis).

Although the environment 400 illustrates a particular configuration of computing resources, it is recognized that the present disclosure is not so limited. In particular, access to sharable resources may be provided from any of a variety of types of computing environments, rather than solely a hosted computing environment 420. The methods described below may provide secure access to such sharable resources in other types of environments.

In various embodiments, the application 414 includes a plurality of code segments (e.g., code segments 1-N) and a plurality of code paths and/or code streams. Furthermore, in an example, the code segments include parallel code fragments with foreign code that is executable by the processor 406B. In an embodiment, the processor 406A executes the application 414 by at least obtaining translated executable code 416 from the firmware 412 or another component of the hosted computing environment 420. In one example, the firmware 412 processing the application 414 (e.g., the executable object that encodes the instructions associated with the application 414), obtains a code segment (e.g., parallel code fragment) including foreign code and provides the foreign code (e.g., a payload as described above) to the processor 406B and returns a result to the application 414/processor 406A executing the application 414.

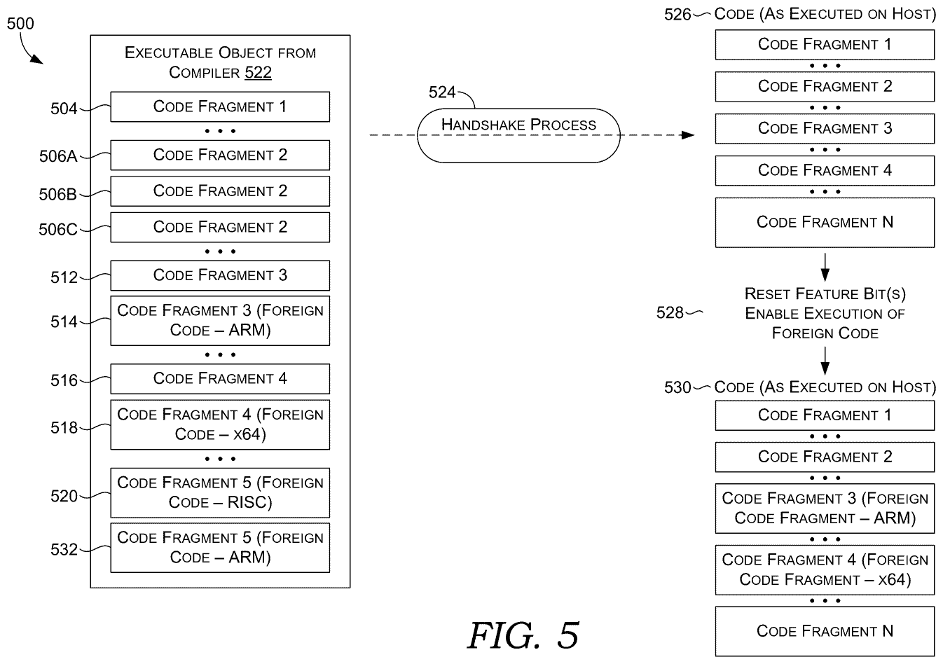

FIG. 5 illustrates an environment 500 in which a collection of executable code that includes parallel code fragments in a hosted computing environment and plurality of processors, in accordance with an embodiment. For example, the environment 500 includes executable code within an executable object 522 obtained from a compiler that includes a plurality of different parallel code fragments and at least a portion of the different parallel code fragments include foreign code. In the example shown, there is a first set of parallel code fragments (shown as Code Fragments 2 506A-506C) that represent alternative versions of the same functional code that can be selectively enabled or disabled by users.

In various embodiments, the executable object 522 includes a second set of parallel code fragments, “Code Fragment 3” 512 and “Code Fragment 3 (Foreign Code-ARM)” 514 which perform the same general functions and/or operations; however, the “Code Fragment 3 (Foreign Code-ARM)” 514 includes executable instructions corresponding to an instruction architecture associated with ARM processors. In one example, the two code fragments execute the same underlying function, but the (Foreign Code-ARM) version is executable by a target processor (e.g., an ARM processor of the hosted computing environment). Accordingly, if the target processor is available, the user, in an embodiment, selectively enables execution of “Code Fragment 3 (Foreign Code—ARM)” 514 during execution of the executable object 522 (e.g., the application). In other embodiments, if the target processor is unavailable the hosted computing environment ignores “Code Fragment 3 (Foreign Code—ARM)” 514 or otherwise prevents the user from selectively enabling code fragments associated with the unsupported/unavailable instruction architecture.

Additionally, in an embodiment, a third set of parallel code fragments, “Code Fragment 4” 516 and “Code Fragment 4 (Foreign Code—x64)” 518, represent a different possible feature that may be introduced at or during execution time of the executable object 522 (e.g., by using a selection mask as described above). Similar to “Code Fragment 3” 512 and “Code Fragment 3 (Foreign Code-ARM)” 514, in various embodiments, the “Code Fragment 4” 516 includes executable instructions that are executable natively (e.g., native to the processor executing the executable object) and the “Code Fragment 4 (Foreign Code—x64)” 518 is executable by a target processor supporting the x64 instruction architecture. Although the parallel code fragments illustrated in FIG. 5 are described in pairs and/or alternatives, the parallel code fragments, in various embodiments, provide additional and/or distinct operations and/or functions. For example, Code Fragment 4″ 516 and “Code Fragment 4 (Foreign Code—x64)” 518, as a result of being executed by one or more processors, cause the processors to perform different operations.

Finally, as illustrated in FIG. 5, in an embodiment, the executable object 522 includes a fourth set of parallel code fragments, “Code Fragment 5 (Foreign Code—RISC)” 520 and “Code Fragment 5 (Foreign Code—RISC)” 532 represent alternatively executing parallel code fragments that allow for selective introduction of operations to be performed by a target processor. In various embodiments, during execution of the executable object 522, a selection mask including a set of feature bits are used to select parallel code fragments from the plurality of parallel code fragments. For example, once an initial set of feature bits are selected (e.g., the selection mask associated with the parallel code fragment is provided to the firmware or another component of the hosted computing environment), the executable object 522 is executed, causing selection of particular parallel code fragments for execution. For example, a handshake process 524 is performed between an operating system and firmware of the hosted computing environment to determine an execution path including parallel code fragments of the executable object 522. In one embodiment, parallel code fragments with foreign code are not enabled and the code as executed by the host includes a first execution path 526, which may include other parallel code fragments of the plurality of code fragments in the executable object 522.

At some point prior to, or during, execution of the executable object 522, one or more feature bits is modified by at least obtaining a selection mask (e.g., in response to a user enabling the parallel code fragments via a user interface). In the example illustrated in FIG. 5, the “Code Fragment 3 (Foreign Code—ARM)” 514 and “Code Fragment 4 (Foreign Code—x64)” 518 have been enabled by at least providing the corresponding selection masks to the firmware or other component of the hosted computing environment. In various embodiments, the operating system determines that feature bits have changed, and causes the corresponding parallel code fragment to be included or otherwise substituted into a second execution path 530 in place of the code fragment in the first execution path 526, at the time of execution. Although the environment 500 illustrates the executable object 522 as including a particular set of parallel code fragments other combinations of executable code, parallel code fragments, and foreign code, including different instruction architectures, can be used in combination with the various embodiments described. Furthermore, in various embodiments, a plurality of different code paths are generated from the executable object 522 which includes the execution of different parallel code fragments and/or foreign code. For example, the user can enable all foreign code including the ARM instruction architecture. In another example, the user can enable a first parallel code fragment including foreign code in the RISC instruction architecture and a second parallel code fragment including foreign code in the x64 instruction architecture.

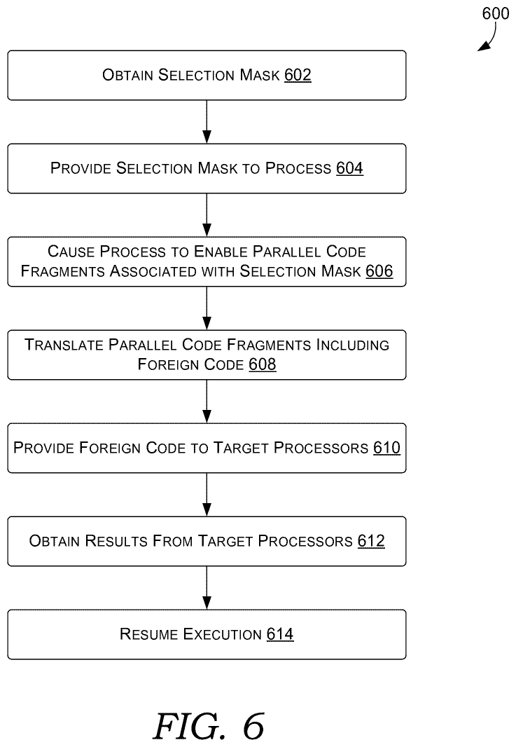

FIG. 6 is a flow diagram showing a method 600 for enabling execution of parallel code fragments with foreign code in accordance with at least one embodiment. The method 600 can be performed, for instance, by the hosted computing environment 120 of FIG. 1. Each block of the methods 600, 700, and 800 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, the system implementing the method 600 obtains a selection mask. As described above in connection with FIG. 1, in various embodiments, the selection mask includes a set of feature bits that indicate to the hosted computing environment executing an executable object that parallel code fragments encoded in the executable object are enabled. In one example, a user determines and/or indicates through a user interface parallel code fragments to enable, and an operating system provides the corresponding selection masks to firmware managing execution of the executable object. Accordingly, in various embodiments, each time code is to be translated for execution (e.g., in response to a new selection mask), computing hardware, features, and/or capabilities of a particular platform can be assessed, with changes to the platform resulting in changes in what code is in fact executed from among the parallel code fragments.

At block 604, the system implementing the method 600 provides the selection mask to a process. For example, the operating system causes the executable object to be executed within a process of the operating system. Continuing this example, at block 604, the system implementing the method 600, providing the selection mask to the process causes the process to selectively enable parallel code fragments with the corresponding selection mask (e.g., set of feature bits). For example, as described above in connection with FIG. 2, the executable object includes the selection mask and metadata that when matched cause execution of the executable object to proceed to the parallel code fragment.

At block 608, the system implementing the method 600 translates the parallel code fragments including foreign code. For example, the firmware translates instructions stored in the hosted computing environment (e.g., the executable object) for execution from an instruction architecture of the hosted computing environment to a native instruction architecture of the target processor. In another example, the instructions are already included in the executable object as a payload or otherwise can be provided to the target processor without translation.

At block 610, the system implementing the method 600 provides the foreign code to the target processor. For example, during a handshake process the target processor is identified as part of the hosted computing environment and capable of executing the foreign code, as such, when enabled, the foreign code is provided to the target processor for execution. At block 612, the system implementing the method 600 obtains the result from the target processor. For example, a result generated by the foreign code is provided (e.g., stored in a memory location) to the process executing the executable object. In other embodiments, the system implementing the method 600 do not wait for the result from the target processor. At block 614, the system implementing the method 600 resumes execution of the executable object. For example, a merge point in the executable code is used to resume execution of the code in the executable object.

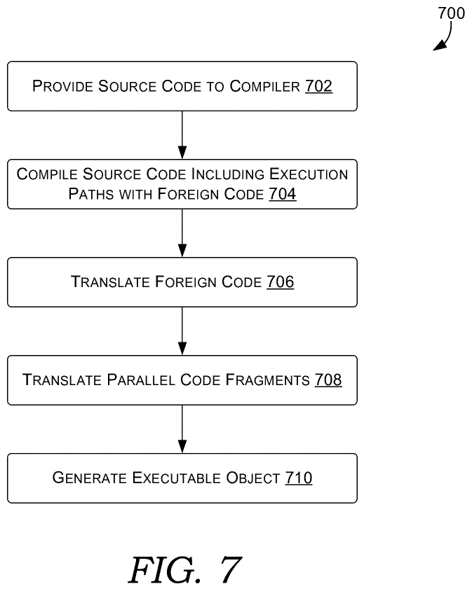

FIG. 7 is a flow diagram showing a method 700 for generating an executable object including parallel code fragments with foreign code in accordance with at least one embodiment. The method 700 can be performed, for instance, by the developer computing environment 104 of FIG. 1. At block 702, the system implementing the method 700 provides source code to a compiler. For example, a developer can generate source code that encodes instructions in a programming language. At block 704, the system implementing the method 700 compiles the source code including execution paths with foreign code. For example, the source code includes or the compiler otherwise determines alternative and/or additional instruction architectures in which the source code is to be encoded.

At block 706, the system implementing the method 700 translates the foreign code. For example, the compiler generates machine code that can be included in an executable object to enable execution of the operations by a processor. At block 708, the system implementing the method 700 translates the parallel code fragments. For example, the compiler generates machine code including selection masks for enabling the parallel code fragments and execution paths including one or more parallel code fragments. At block 710, the system implementing the method 700 generates an executable object. In one example, the compiler encodes the instructions in a format that is executable by the hosted computing environment.

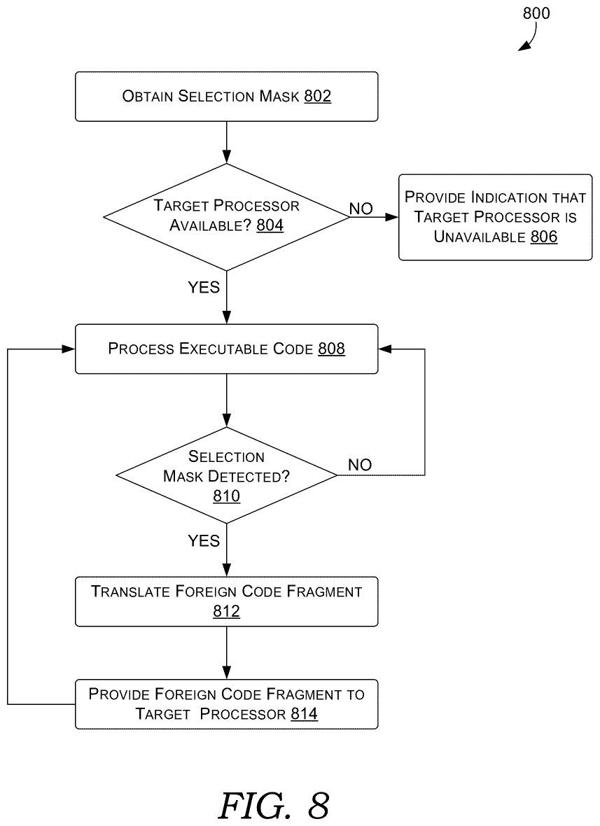

FIG. 8 is a flow diagram showing a method 800 for executing an executable object including parallel code fragments with foreign code using a set of processors in accordance with at least one embodiment. The method 800 can be performed, for instance, by the developer computing environment 104 of FIG. 1. At block 802, the system implementing the method 800 obtains a selection mask. As described above in connection with FIG. 1, in various embodiments, the selection mask includes a set of feature bits that indicate to the hosted computing environment executing the executable object the parallel code fragments encoded in the executable object to enable. For example, the selection mask indicates a target processor, processor capabilities, and/or instruction architecture associated with foreign code included in the parallel code fragment.

At block 804, the system implementing the method 800 determines if the target processor is available. For example, the operating system of the hosted computing environment determines if the target processor is included in the hosted computing environment and continues to block 808. However, if the target processor is not available and/or does not include the capabilities to execute the foreign code, the system implementing the method 800 proceeds to block 806 and indicates that the target processor is unavailable. In some embodiments, the check in block 804 is performed prior to obtaining the selection mask. For example, the hosted computing environment determines (e.g., through negotiation and/or handshake process between firmware and an operating system) the parallel code fragments with foreign code that can be executed by the hosted computing environment.

At block 808, the system implementing the method 800 processes the executable code. For example, the operating system initiates a process to control the execution of the executable object. At block 810, the system implementing the method 800 determines if the selection mask is detected. For example, the executable code is processed, and if no selection mask is determined execution continues (e.g., the system implementing the method 800 returns to block 808). However, if the selection mask is detected, the system implementing the method 800 continues to block 812 and translates the foreign code fragment.

At block 812, the system implementing the method 800 translates the parallel code fragments including foreign code. For example, the firmware translates instructions stored in the hosted computing environment (e.g., the executable object) for execution from an instruction architecture of the hosted computing environment to a native instruction architecture of the target processor. In another example, the instructions are already included in the executable object as a payload or otherwise can be provided to the target processor without translation. At block 814, the system implementing the method 800 provides the foreign code to the target processor. For example, during a handshake process the target processor is identified as part of the hosted computing environment and capable of executing the foreign code, as such, when enabled, the foreign code is provided to the target processor for execution.

Having described embodiments of the present disclosure, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, RGB camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments that are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C); (A and B); (A and C); (B and C); or (A, B and C).”

What is claimed is:

1. A method comprising:
obtaining an executable object associated with a first instruction architecture, the executable object including a parallel code fragment including a foreign code segment associated with a second instruction architecture;
obtaining a selection mask including metadata for identifying the parallel code fragment including the foreign code segment; and
in response to detecting the selection mask in the executable object, enabling execution of the parallel code fragment by at least:
translating the executable object into machine-readable code executable by a first processor;
selecting the parallel code fragment including the foreign code segment based at least in part on the selection mask; and
causing a second processor to execute the foreign code segment, the second processor capable of executing operations included in the second instruction architecture.

2. The method of claim 1, wherein the method further comprises determining a hosted computing environment includes the second processor and the executable object includes the parallel code fragment executable by the second processor.

3. The method of claim 2, wherein the method further comprises determining the second processor is capable of executing the foreign code segment based at least in part on a capability of the second processor.

4. The method of claim 1, wherein the method further comprises obtaining, from the second processor, a result of executing the foreign code.

5. The method of claim 4, wherein the method further comprises continuing execution of the executable object at a merge point based on the result.

6. The method of claim 1, wherein the machine-readable code associated with the parallel code fragment encodes a payload comprising instructions in the second instruction architecture executable by the second processor.

7. The method of claim 1, wherein the executable object includes a plurality of parallel code fragments that are enabled by the selection mask.

8. One or more computer storage media having executable instructions embodied thereon, which, when executed by a processing device, cause the processing device to perform operations comprising:
executing an application based on an executable object encoded in a first instruction architecture, the executable object including a parallel code fragment containing a foreign code segment;
enabling the parallel code fragment based on a selection mask; and
in response to detecting the selection mask in the executable object, executing the parallel code fragment by at least:
translating the parallel code fragment including the foreign code into machine-readable code in a second instruction architecture associated with a target processor; and
causing the target processor to execute the foreign code.

9. The media of claim 8, wherein the processing device further performs the operations comprising resuming execution of the application at a merge point encoded in the executable object in response to obtaining a result of executing the foreign code from the target processor.

10. The media of claim 8, wherein the processing device and the target processor are components of the hosted computing environment.

11. The media of claim 10, wherein the processing device further performs the operations comprising causing an operating system and firmware of the hosted computing environment to perform a handshake operation to determine the parallel code fragment is executable by the hosted computing environment.

12. The media of claim 11, wherein the processing device further performs the operations comprising causing the operating system to update a user interface to indicate that the parallel code fragment is executable by the hosted computing environment.

13. The media of claim 8, wherein executing the application based on an executable object further comprises translating instructions included in the executable code into machine code to be executed by the processing device.

14. The media of claim 8, wherein the selection mask includes metadata indicating a type associated with the target processor.

15. The media of claim 14, wherein the metadata further indicates at least one of: processor capabilities of the target processor, streaming instructions, and the second instruction architecture.

16. A system comprising:
a processor; and
a memory coupled to the processor storing instructions that, as a result of being executed by the processor, cause the processor to:
execute a set of operations encoded in an executable object including a parallel code fragment, where the parallel code fragment includes foreign code associated with an instruction architecture corresponding to a target processor;
determine the parallel code fragment within the executable object is enabled based at least in part on a selection mask associated with the parallel code fragment;
translate the parallel code fragment including the foreign code;
provide to the target processor the foreign code encoded in the instruction architecture; and
obtain a result of executing the foreign code from the target processor.

17. The system of claim 16, wherein translating the parallel code fragment further comprises generating machine code executable by the target processor.

18. The system of claim 16, wherein the processor continues execution of the executable object asynchronously during execution of the foreign code by the target processor.

19. The system of claim 16, wherein determining the parallel code fragment within the executable object is enabled further comprises obtaining the selection mask in response to a user enabling the parallel code fragment in a user interface.

20. The system of claim 16, wherein, prior to obtaining the selection mask, the processor executes the set of operations encoded in the executable object without executing the parallel code fragment.
